(19) United States
(12) Patent Application Publication
(10) Pub. No.: US 2010/0104485 A1
(43) Pub. Date: Apr. 29, 2010

(54) Flow-through thermal cycling device

(75) Inventor: Bob Yuan, Belmont, CA (US)

Correspondence Address: HAVERSTOCK & OWENS LLP, 162 N WOLFE ROAD, SUNNYVALE, CA, 94086, US

(73) Assignee: MicroFluidic Systems, Inc.

(21) Appl. No.: 12/290,249

(22) Filed: Oct. 28, 2008

(51) Int. Cl. B01J 19/00

(52) U.S. Cl. 422/198

(57) ABSTRACT

A thermally controlled device includes a flow-through expandable pouch with a fluid inlet, a fluid outlet, a first side surface, and a second side surface. A first thermoelectric cooler (TEC) is coupled to the first side surface and a second TEC is coupled to the second side surface. The first and second TECs are each tension-loaded to provide a compression force to the first and second side surfaces. When the fluid outlet is closed and a first fluid volume is input to the fluid chamber via the fluid inlet, the pouch expands from an initial state of zero volume to an expanded state of a second volume as the first side surface expands against the compression force of the first TEC to form a first thermal contact between the first side surface and the first TEC, and the second side surface expands against the compression force of the second TEC to form a second thermal contact between the second side surface and the second TEC.

### GOVERNMENT LICENSE RIGHTS

This invention was made with Government support under Agreement No. W81XWH-04-9-0010 awarded by the Government. The Government has certain rights in this invention.

### FIELD OF THE INVENTION

The invention relates to an apparatus for performing thermal cycling. In particular, the invention relates to a flow-through thermal cycling device with a thermally conformable interface.

### BACKGROUND OF THE INVENTION

There is a large need in a multitude of industries (from chemical production to pharmaceutical development), chemical and biological research, and diagnostics to perform thermally-driven chemical reactions. Typically, thermally-driven chemical reactions are performed in reaction vessels with separate heater elements that are in direct contact with the vessel. The vessel can be glass, metal, ceramic, or plastic. Heating a sample within the vessel requires the use of a heater.

The polymerase chain reaction (PCR) is a technique for the amplification of nucleic acids, such as RNA and DNA, in the laboratory. PCR is a common method of creating copies of specific fragments of DNA. PCR rapidly amplifies a single DNA molecule into many billions of molecules. In one application of the technology, small samples of DNA can produce sufficient copies to carry out forensic tests.

PCR is typically performed using thermal cycling in which a sample is subjected to a series of heating and cooling steps. Conventional PCR instruments include a PCR tube for holding the sample and a heater coupled to the PCR tube.

Typically, one end of the PCR tube is closed-ended for retaining the fluid sample, while the other end is open-ended for input of the fluid sample. A fluid line or other fluid input mechanism is coupled to the open end for fluid sample input, after which the open end is sealed to perform the PCR process.

The conventional design approach for PCR tubes and heaters is to use silicon, ceramic or other thermally superior, but relatively expensive materials. These PCR tubes and heaters are not disposable after use and, therefore, need to be integrated as part of the instrument. Under these constraints, the PCR instrument design options include either leaving the PCR tubes in the heaters as part of the instrument and having a sample delivery mechanism interface with it fluidically each time, or using a contact-based heater design approach for each PCR tube to snap in place each time a new PCR tube is inserted, or using hot air/cool air for thermal cycling.

Disadvantages exist for each of these options. Leaving the tube in the heater for repeated thermal cycling eventually leads to material degradation due to thermal fatigue and is not advisable. Further, a fluidic connection between the sample delivery mechanism and the PCR tubes requires a complex sealing interface design, which can lead to contamination issues between each run. In some cases, an operator manually delivers the sample into the PCR tubes. This is manually intensive and does not lend itself to automated applications.

Design of a contact-based heater approach is quite challenging and has drawbacks such as achieving uniform tangential coverage for heating of the tubes and the sample contained therein. Also, there are issues such as tube alignment and registration for establishing a repeatable and acceptable interface between the tubing and heater each time a new PCR tube is inserted.

Using the hot air/cool air approach for thermal cycling is not energy-efficient. Additionally, the hot air/cool air approach has a slower response time than direct contact approaches, the system is more bulky, and oftentimes more noisy.

Heaters used to heat PCR tubes are basically sleeves with a hole in the center through which the tube is inserted. The tube can either be permanently fixed in place within the heater or the tube can be removed from the heater and replaced with a new tube for each new sample to be heated. In the case where the tube is permanently fixed within the heater, the issue of creating the proper contact between the tube and the heater is eliminated, but this creates the problem of properly mating the tube to a sample delivery mechanism for repeated connections and disconnections. Further, the issue of cross-contamination is raised when reusing the same tube for different samples.

In the case where the tube is replaced for each new sample, it is necessary to thread the tube through the sleeve each time the tube is replaced. The problem is creating a repeatable contact between the tube and the heater with each newly introduced tube.

### SUMMARY OF THE INVENTION

A thermal cycling device includes a flow-through thermal cycling chamber configured with a relatively high surface area to volume ratio, the thermal cycling chamber having a relatively small thickness and two side surfaces having relative large surface areas compared to other surfaces of the thermal cycling chamber. The thermal cycling chamber is formed from a thermally conductive, flexible, and expandable material. In some embodiments, the thermal cycling chamber is formed from two, thin sheets of plastic that are heat sealed together. A first thermoelectric cooler (TEC) is coupled to a first side surface of the thermal cycling chamber, and a second TEC is coupled to a second side surface of the thermal cycling chamber. The first TEC and the second TEC are configured to perform a thermal cycling process and to provide active heating and active cooling to a fluid sample within the thermal cycling chamber. In some embodiments, a heat sink is coupled to each TEC. In some embodiments, a fan is coupled to each heat sink. Each TEC, heat sink, and fan form a thermal sub-assembly. In some embodiments, each thermal sub-assembly is tension-loaded to a side surface of the thermal cycling chamber. In other embodiments, one of the thermal sub-assemblies is rigidly mounted at one side surface of the thermal cycling chamber, and the other thermal sub-assembly is tension-loaded to the other side surface of the thermal cycling chamber. In some embodiments, the thermal sub-assemblies are tension-loaded using springs. In other embodiments, other conventional means for applying compression force can be coupled to the thermal sub-assemblies. For simplicity, the means for providing tension are described as spring means, although it is understood that alternative tension means can be used.

In an initial position, the thermal cycling chamber is in a non-expanded state, and the spring-loaded TECs are pressed against opposing side surfaces of the thermal cycling chamber such that a volume of the thermal cycling chamber is approximately zero. As fluid flows into an inlet channel of the thermal cycling chamber, the force of the fluid forces outward the expandable side surfaces of the thermal cycling chamber. An outlet channel of the thermal cycling chamber is closed to prevent fluid from exiting the thermal cycling chamber. The expanding side surfaces press against the TECs, forcing the TECs backward against the spring force. The springs contract to a maximum position, as defined by a spring stop. Once the spring is contracted to the maximum position, additional fluid input into the thermal cycling chamber forces more of the expanding side surfaces to come into contact with the TECs. The pressure of the input fluid flow, the fluid volume, and the force of the spring-loaded TECs forms a thermal contact interface between the side surface of the thermal cycling chamber and the contact surface of the TEC. By design, the expanded thermal cycling chamber has a relatively small thickness, for example the distance between the two side surfaces, compared to the dimensions of the side surfaces in contact with the TECs, thereby establishing a relatively high surface area to volume ratio.

A thermal cycling process is then performed on the fluid within the thermal cycling chamber. The high surface area to volume ratio of the thermal cycling chamber, the thinness of the plastic sheet that forms the thermal cycling chamber, and the active heating and active cooling of the fluid results in a faster thermal cycling process than conventional methodologies.

The thermal cycling device can be implemented as a stand-along device, or can be combined with other sample preparation modules. Such a combination can be implemented by connecting a series of separate sample preparation apparatuses, or can be completely or partially integrated as a single apparatus, such as a cartridge. An exemplary configuration of a microfluidic cartridge can have a plurality of processing modules, chambers, or areas, including, but not limited to, an input chamber to receive a fluid sample having one or more target analytes, one or more sample preparation modules, and an output chamber, each coupled via microfluidic circuitry. Microfluidic circuitry can include, but is not limited to, fluid lines and valves for directing fluid flow, including the fluid sample and any target analytes included therein. The microfluidic circuitry can also include a fluid pumping means. The fluid pumping means can be included within the microfluidic cartridge, or as an external device coupled to the microfluidic cartridge. The microfluidic cartridge, including the TECs of the thermal cycling device, can be coupled to an external power source via electrical contacts. In some embodiments, the microfluidic cartridge is coupled to a control module to automate processing of the fluid sample. The control module can be integrated into the microfluidic cartridge, or can be a separate module externally coupled to the microfluidic cartridge.

These and other advantages will become apparent to those of ordinary skill in the art after having read the following detailed description of the embodiments which are illustrated in the various drawings and figures.

### BRIEF DESCRIPTION OF THE DRAWINGS

The accompanying drawings, which are incorporated in and form a part of this specification, illustrate embodiments of the invention and, together with the description, serve to explain the principles of the invention but not limit the invention to the disclosed examples.

FIG. 1 illustrates an isometric view of an exemplary thermal cycling device.

FIG. 2 illustrates an isometric view of the thermal cycling chamber sub-assembly.

FIG. 3 illustrates a cut out side view of the thermal cycling device with the thermal cycling chamber in an initial state.

FIG. 4 illustrates a cut out side view of the thermal cycling chamber and TECs of FIG. 3.

FIG. 5 illustrates a cut out side view of the thermal cycling device with the thermal cycling chamber in a fully expanded state.

FIG. 6 illustrates a cut out side view of the thermal cycling chamber and TECs of FIG. 5.

FIG. 7 illustrates a cut out side view of the thermal cycling device in FIG. 5 coupled to an exemplary mounting mechanism.

FIG. 8 illustrates a cut out side view of the thermal cycling device and mounting mechanism with the thermal cycling chamber in the expanded state.

FIG. 9 illustrates a block diagram of an exemplary configuration of a microfluidic cartridge including the thermal cycling device.

The present invention is described relative to the several views of the drawings. Where appropriate and only where identical elements are disclosed and shown in more than one drawing, the same reference numeral will be used to represent such identical elements.

### DETAILED DESCRIPTION OF THE PRESENT INVENTION

Reference will now be made in detail to the embodiments of the thermal cycling device of the invention, examples of which are illustrated in the accompanying drawings. While the invention will be described in conjunction with the embodiments below, it will be understood that they are not intended to limit the invention to these embodiments and examples. On the contrary, the invention is intended to cover alternatives, modifications and equivalents, which may be included within the spirit and scope of the invention as defined by the appended claims. Furthermore, in the following detailed description of the present invention, numerous specific details are set forth in order to more fully illustrate the present invention. However, it will be apparent to one of ordinary skill in the prior art that the present invention may be practiced without these specific details. In other instances, well-known methods and procedures, components and processes haven not been described in detail so as not to unnecessarily obscure aspects of the present invention.

Embodiments of the present invention are directed to a thermal cycling device configured to perform a thermal cycling process. The thermal cycling device includes a thermal cycling chamber formed as a pouch between two thermally conductive sheets, and two heating and cooling thermal devices that are spring-loaded and coupled to the thermal cycling chamber. For simplicity, the function and characteristics of the thermal devices are described in terms of a thermoelectric cooler that provides active heating and active cooling. It is understood that alternative thermal devices can be used. The configuration of the thermal cycling device addresses the problem of inconsistent thermal contact between heating/cooling elements (TECs) and the thermal cycling chamber holding the fluid sample to be processed. Two TECs are used to thermally cycle a fluid sample sandwiched in between.

To reduce variability in thermal contact between the TECs and the thermal cycling chamber, the sheets forming the thermal cycling chamber are expandable and flexible, analogous in some respects to a balloon, and each TEC is spring-loaded to provide a contracting force on the thermal cycling chamber positioned there between, such as the balloon being pressed against a wall. In an initial state, the thermal cycling chamber is compressed by the spring-loaded TECs to a flat configuration with substantially zero volume. As fluid is input to the thermal cycling chamber, while the downstream side of the thermal cycling chamber is closed, such as by a fluid valve, the pouch that is the thermal cycling chamber expands, thereby providing an outward force against the spring-loaded TECs. The TECs are forced backward until reaching a stop, which defines a maximum thickness of the thermal cycling chamber. The outward force exerted by the input fluid, and the contracting force provided by the spring-loaded TECs forms a thermal contact between the side surfaces of the thermal cycling chamber and the TECs. This increases the heat transfer and thermal cycling efficiency. Expansion of the thermal cycling chamber is finely controlled by the amount of fluid that is input, the footprint (shape) of the thermal cycling chamber, the spring force applied to the TECs, and the placement of stops to regulate maximum movement of the TECs.

The thermal cycling chamber has a high surface area to volume ratio. In some embodiments, the thermal cycling chamber has a relatively small thickness and two relatively large side surfaces exposed to the TECs. The sheets that form the two side surfaces of the thermal cycling chamber are relatively thin so as to improve thermal efficiency between the TECs and fluid contained within the thermal cycling chamber. In some embodiments, the sheets are made of a thermally conductive flexible and expandable material, such as plastic or other polymer.

TECs are used to provide active heating and active cooling of the fluid within the thermal cycling chamber. Conventional thermal cycling chambers use a heating plate to heat the fluid, and a fan to cool the heating plate. Use of active cooling within the thermal cycling device of the present invention reduces the time of the thermal cycling process.

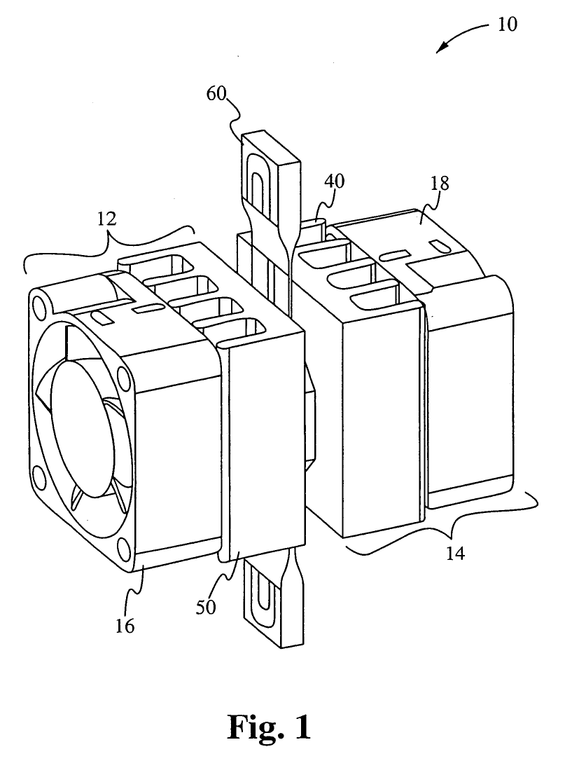

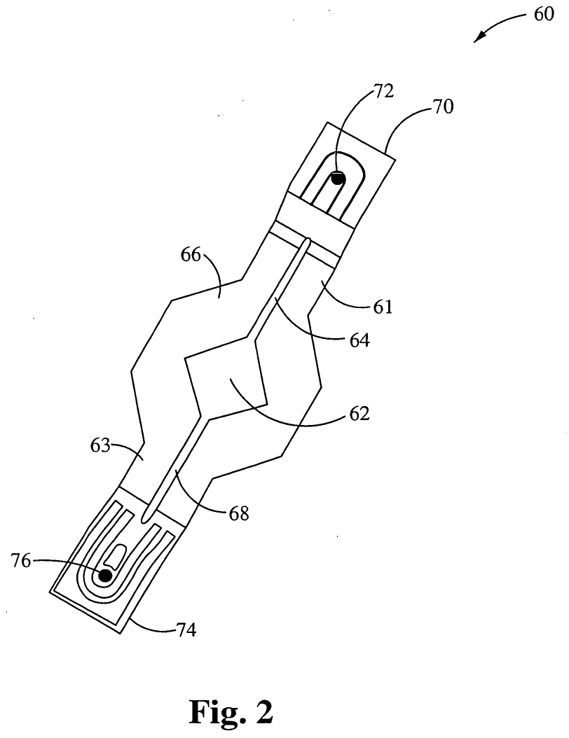

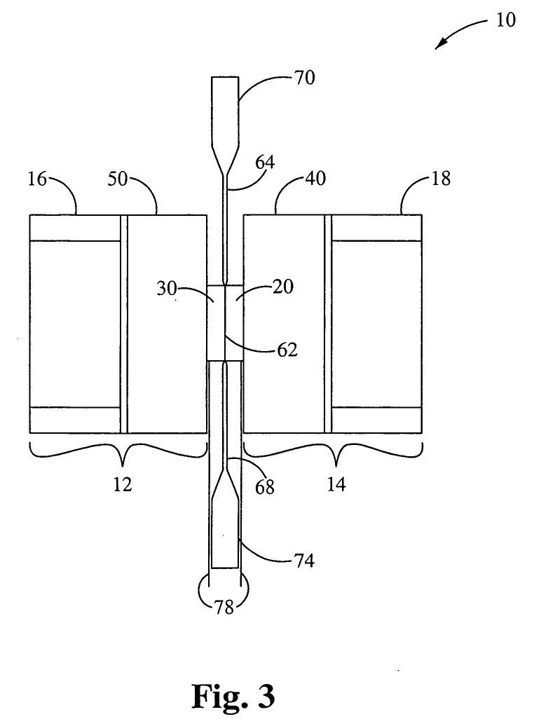

FIG. 1 illustrates an isometric view of an exemplary thermal cycling device. The thermal cycling device 10 includes a thermal cycling chamber sub-assembly 60, a first thermal sub-assembly 12, and a second thermal sub-assembly 14. The thermal sub-assembly 12 includes a heat sink 50, a fan 16, and a TEC 30 (FIG. 3). The thermal sub-assembly 14 includes a heat sink 40, a fan 18, and a TEC 20 (FIG. 3).

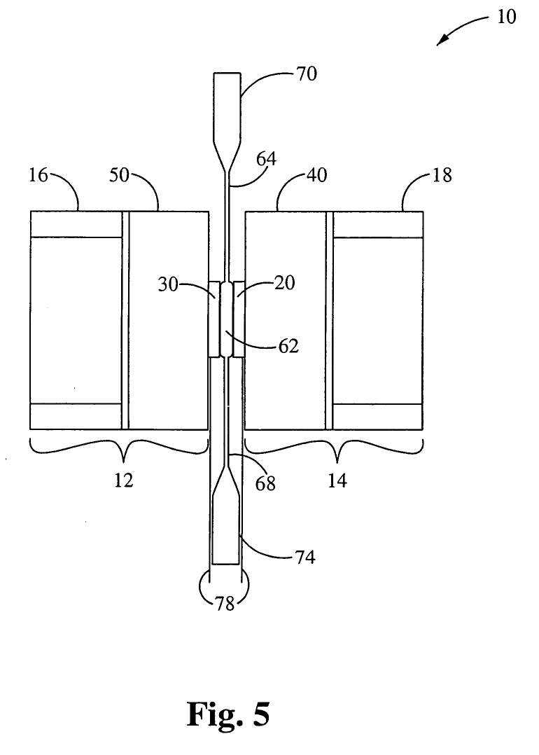

FIG. 2 illustrates an isometric view of the thermal cycling chamber sub-assembly 60. The thermal cycling chamber sub-assembly 60 includes a thermal cycling chamber 62 formed within an expandable vessel 66. In some embodiments, the expandable vessel 66 is formed from two thin sheets sealed together, such as heat sealed, except for portions that form the thermal cycling chamber 60, an inlet channel 64, and an outlet channel 68. Each of the two sheets forms one of the side surfaces of the thermal cycling chamber 62. A first of the side surfaces is coupled to the TEC 20 (FIG. 3) and a second of the side surfaces is coupled to the TEC 30 (FIG. 3). A first end 61 of the expandable vessel 66 is coupled to a support tab 70, and a second end 63 of the expandable vessel 66 is coupled to a support tab 74. The support tab 72 includes a fluid input port 72 that is coupled to the fluid inlet channel 64. The support tab 74 includes a fluid output port 76 that is coupled to the fluid outlet channel 68. The support tabs 72 and 74 provide a rigid support for mounting the thermal cycling chamber sub-assembly 60 to a support structure, such as a support structure 80 in FIG. 5. The support tabs 72 and 74 also provide a rigid support for coupling fluid input and output lines (not shown) to the thermal cycling chamber sub-assembly 60, for example an input fluid line coupled to the fluid inlet port 72 and an output fluid line coupled to the fluid outlet port 74.

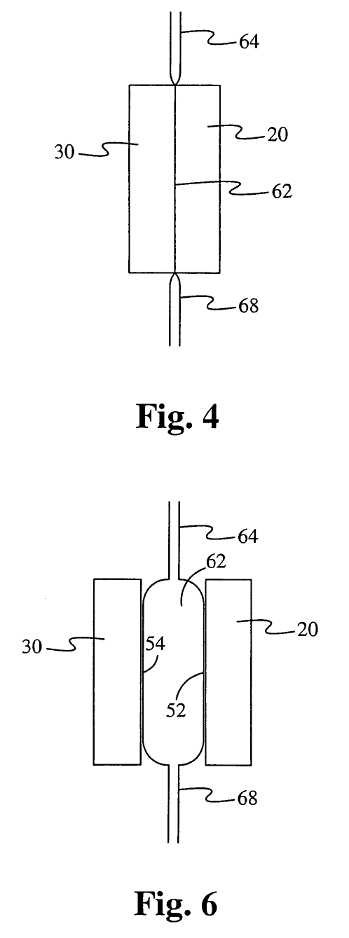

FIG. 3 illustrates a cut out side view of the thermal cycling device 10 with the thermal cycling chamber 62 in an initial state. FIG. 4 illustrates a cut out side view of the thermal cycling chamber 62 and TECs 20 and 30 of FIG. 3. The TEC 20 and the TEC 30 are each aligned to sandwich the thermal cycling chamber 62. In the initial state, the compression force applied by the TECs 20 and 30 compress the thermal cycling chamber 62 into a flat, substantially zero volume, configuration. An advantage of this zero volume initial state is that little if any air is trapped within the thermal cycling chamber 62.

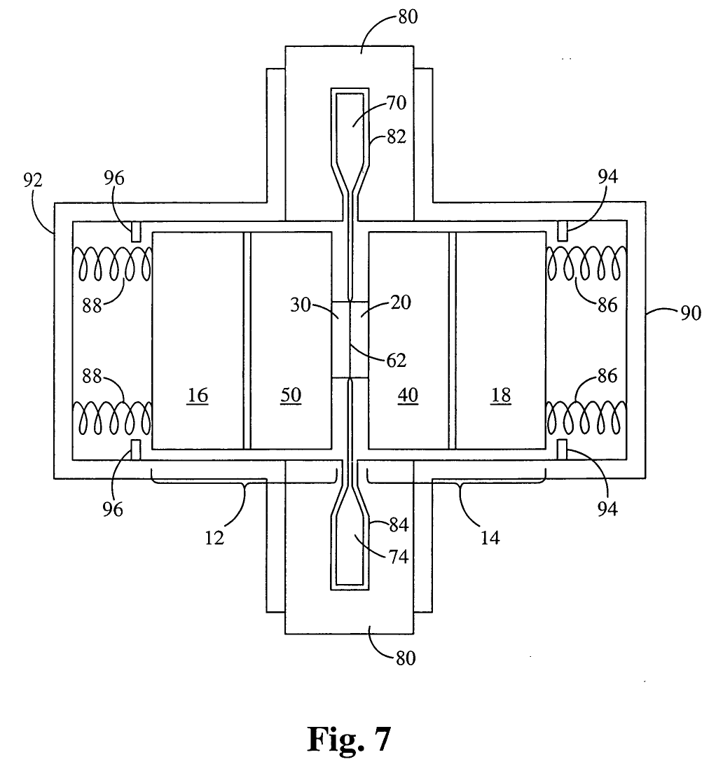

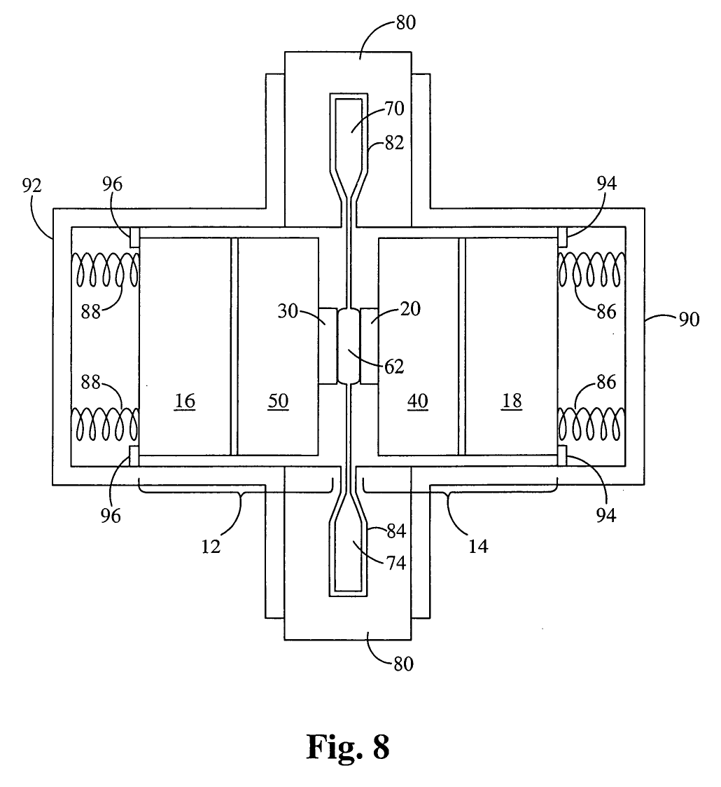

FIG. 5 illustrates a cut out side view of the thermal cycling device 10 with the thermal cycling chamber 62 in a fully expanded state. FIG. 6 illustrates a cut out side view of the thermal cycling chamber 62 and TECs 20 and 30 of FIG. 5. A downstream side of the thermal cycling chamber 62 is closed to prevent fluid from exiting the thermal cycling chamber 62. In some embodiments, a fluid valve (not shown) is coupled to either the outlet channel 68 or to an external fluid line coupled to the fluid outlet 76. As fluid is pumped into the thermal cycling chamber via the fluid inlet 72 and the inlet channel 64, the expanding side surfaces of the thermal cycling chamber 62 press against the TECs 20 and 30, forcing the TECs 20 and 30 backward against the compression force provided by springs 86 and 88 (FIGS. 7). The springs 86 and 88 contract to a maximum position, as defined by spring stops 94 and 96, respectively. Once each spring 86 and 88 is contracted to the maximum position, additional fluid input into the thermal cycling chamber 62 forces more of the expanding side surfaces to come into contact with the TECs 20 and 30. The force of input fluid flow and the force of the spring-loaded TECs 20 and 30 forms a thermal contact interface between the two side surfaces of the thermal cycling chamber 62 and the contact surface of each of the TECs 20 and 30. Due also to the compression force applied by the TECs 20 and 30, the expanded thermal cycling chamber 62 has a relatively small thickness, for example the distance between the two side surfaces, compared to the dimensions of the side surfaces in contact with the TECs, thereby establishing a relatively high surface area to volume ratio. Each of the TECs 20 and 30 are coupled to a power source (FIG. 8) so as to thermally cycle between a first temperature and a second temperature.

As shown in FIG. 6, the thermal cycling chamber 62 is in its fully expanded state with a relatively narrow thickness as compared to the relatively large contact side surfaces, as exemplified by the side surface areas 52 and 54. Such a configuration results in a relatively large surface area to volume ratio of the thermal cycling chamber 62, and in particular a relatively large surface area of the side surfaces 52 and 54 that are thermally coupled with the TECs 20 and 30, respectively. The shapes and relative dimensions of the thermal cycling chamber 62 and the TECs 20 and 30 are for exemplary purposes only.

The thickness of the thermal cycling chamber is relatively small compared to the other dimensions of the thermal cycling chamber so as to provide a greater surface area to volume ratio. In some embodiments, the thickness of the thermal cycling chamber while in the fully expanded state is less than or equal to 1 mm. In some embodiments, the volume of the thermal cycling chamber while in the fully expanded state is in the range of about 15-25 ul. The thermal cycling process is a cycle of heating the fluid sample and cooling the fluid sample between a specified temperature range. The time for each thermal cycle is dependent on the amount of time to heat and cool the fluid sample to the desired temperatures. The TECs enable active heating and active cooling. The active heating and active cooling of the fluid sample, the relatively large surface area to volume ratio of the thermal cycling chamber, the relatively large surface area of the thermal chamber side surfaces in thermal contact with the TECs, as well as the relative thinness of the side surface membrane all contribute to shortening the thermal cycle and decreasing the time to complete the entire thermal cycling process.

Additionally, the relatively large surface area to volume ratio of the thermal cycling chamber and the relatively large surface area of the chamber housing side surfaces in thermal contact with the TECs enables the TECs to operated at relatively low power, when compared to conventional PCR devices.

Once the thermal cycling process is completed, the fluid sample is removed from the thermal cycling chamber 62 by opening the downstream fluid channel, for example opening the fluid valve. With the downstream fluid channel open, the compression force applied by the TECs 20 and 30 force the fluid sample out of the thermal cycling chamber 62, through the fluid outlet channel 68, and out the fluid outlet 76. In some embodiments, a fluid valve is coupled to the inlet channel 64, or to the external fluid line coupled to the fluid inlet 72. In this configuration, the fluid valve is closed to prevent the fluid sample from back flowing through the inlet channel 64 when the downstream fluid channel is open. In other embodiments, the inlet channel 64 remains open and under pressure from the pumping means that inputs fluid through the fluid inlet 72. This pumping pressure prevents the fluid sample from back flowing through the inlet channel 64 and can also be used to force the fluid sample out of the thermal cycling chamber 62 and into the outlet channel 68.

To apply the compression force to the thermal cycling chamber 62, the thermal sub-assemblies 12 and 14 are each coupled to mounting mechanism. In some embodiments, the mounting mechanism includes a brace and support structure. FIG. 7 illustrates a cut out side view of the thermal cycling device 10 in FIG. 5 coupled to an exemplary mounting mechanism. The mounting mechanism includes a support structure 80 and braces 90 and 92. The support structure 80 can be a stand-alone structure or can be part of a larger apparatus of which the thermal cycling device 10 is a part. The support structure 80 can be a single structure positioned around a perimeter of the thermal cycling device 10. Alternatively, the support structure can comprise multiple separate support structures, one positioned on each end of the thermal cycling sub-assembly 60.

The support structure 80 includes a first depression 82 into which the support tab 70 is inset, and a second depression 84 into which the support tab 74 is inset. In some embodiments, the thermal cycling sub-assembly 60 is designed for single-use and to be disposable, in which case the thermal cycling sub-assembly 60 is removably coupled to the support structure 80. In general, the support tabs 70 and 74 can be secured into the depressions 82 and 84 using any conventional securing method including, but not limited to, clamps, screws, press fit, solvent bond or other adhesive. In some embodiments, an o-ring (not shown) can be used to seal the fluid connection between the fluid ports 72 and 76 in the support tabs and an externally coupled fluid line or fluid channel.

Springs 86 are coupled to the brace 90, and the brace 90 is coupled to the support structure 80. Springs 88 are coupled to the brace 92, and the brace 92 is coupled to the support structure 80. The braces 90 and 92 are mounted to the support structure using any conventional mounting means including, but not limited to, clamps, screws, solvent bond or other adhesive. The braces 90 and 92 remain stationary relative to the support structure 80, however the thermal sub-assemblies 12 and 14 move relative to the support structure 80 and the braces 90 and 92.

As shown in FIG. 7, the thermal cycling chamber 62 is in the initial state, where the TECs 20 and 30 are compressed together such that the thermal cycling chamber 62 is substantially flat. In this initial state configuration, the heat sink 16 is not pressed against the stops 96 and the heat sink 18 is not pressed against the stops 94.

FIG. 8 illustrates a cut out side view of the thermal cycling device and mounting mechanism with the thermal cycling chamber 62 in the expanded state, as in FIG. 6. In this expanded state configuration, the heat sink 16 is pressed against the stops 96 and the heat sink 18 is pressed against the stops 94.

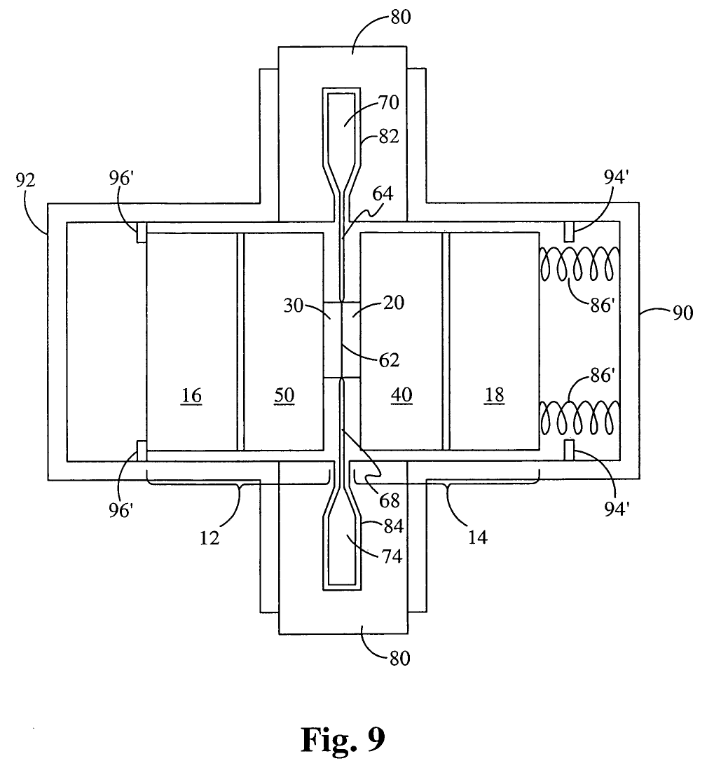

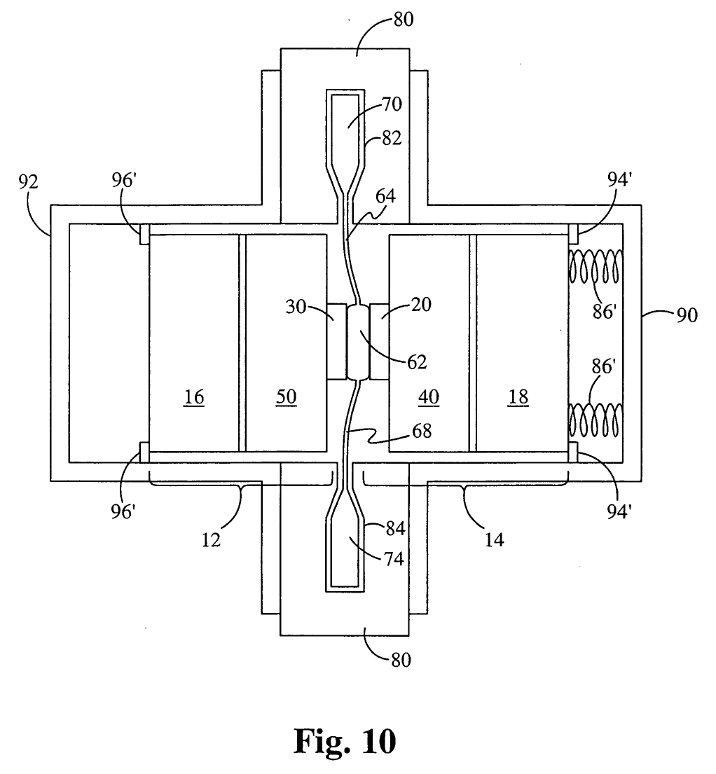

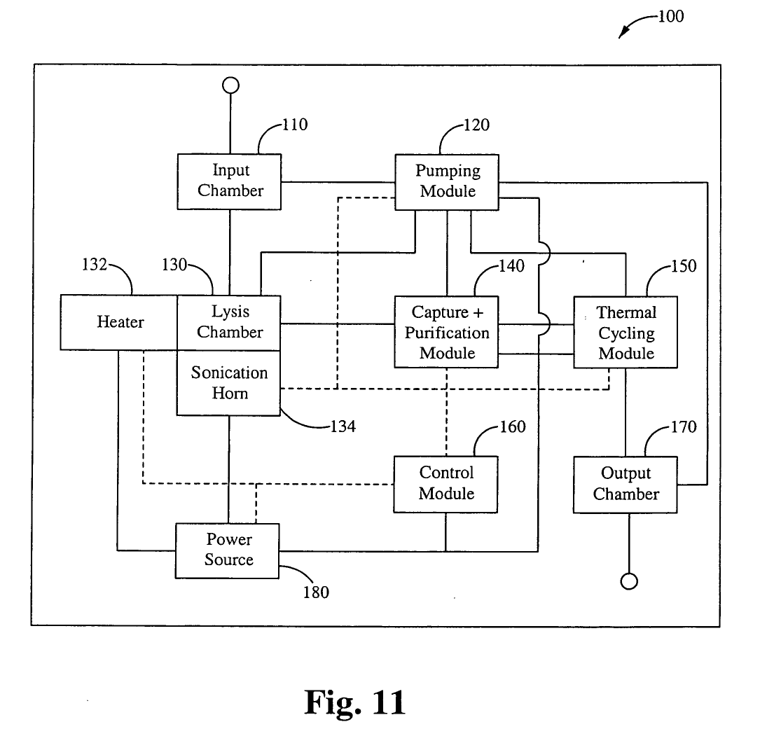

The mounting mechanism of FIGS. 7 and 8 includes a tension-loaded mechanism, for example the springs 86 and 88, coupled to each of the thermal sub-assemblies 12 and 14. In an alternative configuration, one of the thermal sub-assemblies is rigidly mounted to remain in place when the thermal cycling chamber 62 expands. FIG. 9 illustrates a cut out side view of the thermal cycling device 10 in FIG. 5 coupled to an exemplary alternative mounting mechanism, where one of the thermal sub-assemblies is rigidly mounted. The alternative mounting mechanism of FIG. 9 functions similarly as the mounting mechanism in FIGS. 7 and 8 except that the first thermal sub-assembly 12, which includes the TEC 30, the heat sink 50, and the fan 16, is rigidly mounted to the brace 92. In this alternative configuration, the springs 88 from FIGS. 7 and 8 are eliminated. The fixed position of the thermal sub-assembly 12 is determined by stops 96′. The fixed position of the thermal sub-assembly 12 is shown in FIG. 9 to be the same position as the initial position of the thermal sub-assembly 12 in the configuration shown in FIGS. 7 and 8. Alternatively, the position of the stop 96′, and therefore the fixed position of the thermal sub-assembly 12, can be positioned in any position between that shown in FIG. 9 and that shown in FIGS. 7 and 8. Still alternatively, the brace 92 can be re-configured to contact the fan 16, thereby eliminating the gap between the fan 16 and the brace 92 (previously occupied by the springs 88 in FIGS. 7 and 8) and also eliminating and performing the function of the stops 96′. The alternative mounting mechanism in FIG. 9 also differs from the mounting mechanism in FIGS. 7 and 8 in that the stops 94 are moved further away from the initial position of the fan 18. This alternative position of the stops is shown as stops 94′. This configuration allows for the additional movement of the thermal sub-assembly 14 to accommodate the entire expansion of the thermal cycling chamber 62, since the thermal sub-assembly 12 is rigidly mounted and does not take up any of the expansion.

FIG. 10 illustrates a cut out side view of the thermal cycling device and the alternative mounting mechanism of FIG. 9 with the thermal cycling chamber 62 in the expanded state, as in FIG. 6. In this expanded state configuration, the heat sink 18 is pressed against the stops 94′. Since the thermal sub-assembly 12 is fixed in position during the expansion of the thermal cycling chamber 62, any expansion of the thermal cycling chamber 62 is translated entirely to movement of the thermal sub-assembly 14, instead of to both the thermal sub-assembly 12 and thermal sub-assembly 14 as in FIGS. 7 and 8. Additionally, the rigid position of the thermal sub-assembly 12 results in a positional shift of the expanded thermal cycling chamber 62 relative to the inlet channel 64 and the outlet channel 68. As shown in FIG. 10, the expanded thermal cycling chamber 62 is shifted to the right relative to the inlet channel 64 and the outlet channel 68. The flexible nature of the vessel material 66 that forms the inlet channel 64 and the outlet channel 68 enables bending of the channels 64 and 68 to accommodate the shifting position of the expanded thermal cycling chamber 62.

In an exemplary application, the thermal cycling device is included within a portable apparatus, such as a microfluidic cartridge. In other applications, the thermal cycling device is included as part of another processing apparatus, or is used as a stand-alone device. FIG. 11 illustrates a block diagram of an exemplary configuration of a microfluidic cartridge. The cartridge 100 includes an input chamber 110, an output chamber 170, a pumping module 120, and a plurality of sample preparation modules. In the exemplary configuration of FIG. 11, the sample preparation modules include a lysis module that has a lysis chamber 130, a capture and purification module 140, and a thermal cycling module 150. The lysis module can optionally include a heater 132 and/or a sonication horn 134, each coupled to the lysis chamber 130. The thermal cycling module 150 includes the thermal cycling device 10 of FIGS. 1-10. The input chamber 110, the lysis chamber 130, the capture and purification module 140, the thermal cycling module 150, the output chamber 170, and the pumping module 120 are each coupled via microfluidic circuitry. Microfluidic circuitry can include, but is not limited to, fluid lines and valves for directing fluid flow, including the fluid sample and any target analytes included therein. The pumping module 120 can also be considered part of the microfluidic circuitry, as the pumping means included within the pumping module 120, as well as the fluid lines and valves are all integral in providing fluid flow within the cartridge 100. In some embodiments, the pumping module is included within the cartridge 100, as shown in FIG. 11. In other embodiments, the pumping module, or one more components thereof, is an external device coupled to the microfluidic cartridge.

The input chamber 110 receives an input fluid sample having one or more target analytes to be processed. The fluid sample is transported to and processed within one or more of the sample preparation modules within the cartridge 100. The microfluidic circuitry, including the pumping module 120, is configured to direct the fluid sample and other fluid solutions and reagents within the cartridge. The cartridge 100 can include solutions vessels (not shown) for storing various solutions and reagents used in the sample preparation modules. Alternatively, the cartridge is coupled to external solutions vessels, and the solutions are selectively input and directed to the proper sample preparation module by the microfluidic circuitry.

In some embodiments, the microfluidic cartridge is coupled to a control module 160 to automate processing of the fluid sample. The control module 160 can be integrated into the microfluidic cartridge, as shown in FIG. 11, or the control module can be a separate module externally coupled to the microfluidic cartridge. In some embodiments, the power source 180 is included within the microfluidic cartridge 100, as shown in FIG. 11. The power source 180 is coupled to the heater 132, the sonication horn 134, the control module 160, the pumping module 120, the capture and purification module 140, and the thermal cycling module 150. In other embodiments, the cartridge does not include an internal power source and instead is coupled to an external power source via electrical contacts.

It is understood that the cartridge 100 shown in FIG. 11 is an exemplary configuration and that alternative configurations using different combinations, types, and quantities of modules in combination with the thermal cycling device of the present invention is also contemplated.

In other applications, the thermal cycling device is included as part of another processing apparatus, or is used as a stand-alone device. In some embodiments, one or more heat sinks are coupled to each TEC to remove heat.

In some embodiments, the thermal cycling device is configured to perform PCR thermal cycling. In other embodiments, the thermal cycling device is configured for any type of thermally-driven process, or more generally as a means for producing a thermal reaction.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A thermally controlled device comprising:
a. a flow-through fluid chamber configured to store a fluid sample, the fluid chamber including a fluid inlet, a fluid outlet, a first side surface, and a second side surface, wherein the fluid chamber is comprised of an expandable material;
b. a fluid valve coupled to the fluid outlet of the fluid chamber;
c. a first thermal element coupled to the first side surface of the fluid chamber; and
d. a second thermal element coupled to the second side surface of the fluid chamber, wherein when the fluid valve is closed and a first fluid volume is input to the fluid chamber via the fluid inlet, the first side surface expands to form a first thermal contact between the first side surface and the first thermal element and the second side surface expands to form a second thermal contact between the second side surface and the second thermal element.

2. The device of claim 1 wherein the first thermal element and the second thermal element are each tension-loaded, wherein when the first side surface expands, the first thermal element is forced backward and when the second side surface expands, the second thermal element is forced backward.

3. The device of claim 2 wherein when the fluid valve is open, the tension-loaded first thermal element and the tension-loaded second thermal element are configured to compress towards each other, thereby forcing the fluid sample out of the fluid outlet.

4. The device of claim 1 wherein the first side surface and the second side surface are configured to conform to a contour of a contact surface of the first thermal element and the second thermal element.

5. The device of claim 1 wherein the fluid chamber consists of two thermally conductive, expandable sheets sealed to each other so as to form the fluid chamber, an inlet channel to the fluid chamber, and an outlet channel from the fluid chamber such that the fluid chamber, the inlet channel, and the outlet channel are formed between the two sheets.

6. The device of claim 5 further comprising a first support tab coupled to the inlet channel and a second support tab coupled to the outlet channel.

7. The device of claim 1 wherein the fluid chamber is configured such that the first side surface and the second side surface form approximately an entire surface area of the fluid chamber.

8. The device of claim 1 wherein the first thermal element comprises a first thermoelectric cooler and the second thermal element comprises a second thermoelectric cooler.

9. The device of claim 8 wherein the first thermoelectric cooler and the second thermoelectric cooler are configured to thermally cycle to provide active heating and active cooling to the fluid sample within the fluid chamber.

10. The device of claim 8 further comprising a first heat sink coupled to the first thermoelectric cooler and a second heat sink coupled to the second thermoelectric cooler.

11. The device of claim 10 further comprising a first fan coupled to the first heat sink and a second fan coupled to the second heat sink.

12. The device of claim 1 wherein a volume of the fluid chamber expands and contracts between a first volume and a second volume.

13. The device of claim 12 wherein the first volume is approximately zero.

14. The device of claim 12 wherein the second volume is approximately 15-25 micro liters.

15. The device of claim 1 wherein the fluid chamber is made of a polymer material.

16. The device of claim 1 further comprising a control module coupled to the first thermal element and the second thermal element, wherein the control module is configured to control the temperature of the first thermal element and the second thermal element.

17. The device of claim 1 further comprising a mounting mechanism coupled to the first thermal element and the second thermal element.

18. The device of claim 17 further comprising at least one spring coupled between the first thermal element and the mounting mechanism and at least one spring coupled between the second thermal element and the mounting mechanism.

19. The device of claim 1 wherein the first thermal element is rigidly mounted and the second thermal element is tension-loaded, wherein when the second side surface expands, the second thermal element is forced backward while the first thermal element remains in place.

20. A thermally controlled device comprising:
a. a flow-through fluid chamber configured to store a fluid sample, the fluid chamber including a fluid inlet, a fluid outlet, a first side surface, and a second side surface, wherein the fluid chamber is comprised of an expandable material;
b. a fluid valve coupled to the fluid outlet of the fluid chamber;
c. a first thermal element coupled to the first side surface of the fluid chamber; and
d. a second thermal element coupled to the second side surface of the fluid chamber, wherein when the fluid valve is closed and a first fluid volume is input to the fluid chamber via the fluid inlet, the fluid chamber expands from a first volume to a second volume as the first side surface expands to form a first thermal contact between the first side surface and the first thermal element and the second side surface expands to form a second thermal contact between the second side surface and the second thermal element, further wherein the first volume is approximately a zero volume.

21. The device of claim 20 wherein the first thermal element and the second thermal element are each tension-loaded, wherein when the first side surface expands, the first thermal element is forced backward and when the second side surface expands, the second thermal element is forced backward.

22. The device of claim 21 wherein when the fluid valve is open, the tension-loaded first thermal element and the tension-loaded second thermal element are configured to compress towards each other, thereby forcing the fluid sample out of the fluid outlet.

23. The device of claim 20 wherein the first side surface and the second side surface are configured to conform to a contour of a contact surface of the first thermal element and the second thermal element.

24. The device of claim 20 wherein the fluid chamber consists of two thermally conductive, expandable sheets sealed to each other so as to form the fluid chamber, an inlet channel to the fluid chamber, and an outlet channel from the fluid chamber such that the fluid chamber, the inlet channel, and the outlet channel are formed between the two sheets.

25. The device of claim 24 further comprising a first support tab coupled to the inlet channel and a second support tab coupled to the outlet channel.

26. The device of claim 20 wherein the fluid chamber is configured such that the first side surface and the second side surface form approximately an entire surface area of the fluid chamber.

27. The device of claim 20 wherein the first thermal element comprises a first thermoelectric cooler and the second thermal element comprises a second thermoelectric cooler.

28. The device of claim 27 wherein the first thermoelectric cooler and the second thermoelectric cooler are configured to thermally cycle to provide active heating and active cooling to the fluid sample within the fluid chamber.

29. The device of claim 27 further comprising a first heat sink coupled to the first thermoelectric cooler and a second heat sink coupled to the second thermoelectric cooler.

30. The device of claim 29 further comprising a first fan coupled to the first heat sink and a second fan coupled to the second heat sink.

31. The device of claim 20 wherein the second volume is approximately 15-25 micro liters.

32. The device of claim 20 wherein the fluid chamber is made of a polymer material.

33. The device of claim 20 further comprising a control module coupled to the first thermal element and the second thermal element, wherein the control module is configured to control the temperature of the first thermal element and the second thermal element.

34. The device of claim 20 further comprising a mounting mechanism coupled to the first thermal element and the second thermal element.

35. The device of claim 34 further comprising at least one spring coupled between the first thermal element and the mounting mechanism and at least one spring coupled between the second thermal element and the mounting mechanism.

36. The device of claim 20 wherein the first thermal element is rigidly mounted and the second thermal element is tension-loaded, wherein when the second side surface expands, the second thermal element is forced backward while the first thermal element remains in place.

37. A thermally controlled device comprising:
a. a flow-through thermal cycling chamber configured to store a fluid sample, the fluid chamber including a fluid inlet, a fluid outlet, a first side surface, and a second side surface, wherein the fluid chamber including the first side surface and the second side surface is comprised of an expandable material;
b. a fluid valve coupled to the fluid outlet of the thermal cycling chamber;
c. a first thermoelectric cooler coupled to the first side surface of the fluid chamber, wherein the first thermoelectric cooler is tension-loaded to provide a first compression force; and
d. a second thermoelectric cooler coupled to the second side surface of the fluid chamber, wherein the second thermoelectric cooler is tension-loaded to provide a second compression force, further wherein when the fluid valve is closed and a first fluid volume is input to the fluid chamber via the fluid inlet, the fluid chamber expands from an initial state of zero volume to an expanded state of a second volume as the first side surface expands against the first compression force to form a first thermal contact between the first side surface and the first thermoelectric cooler and the second side surface expands against the second compression force to form a second thermal contact between the second side surface and the second thermoelectric cooler.
